(19) United States
(12) Patent Application Publication
(10) Pub. No.: US 2012/0330473 A1
(43) Pub. Date: Dec. 27, 2012

(54) SYSTEM AND METHOD FOR MANAGING LOADS

(76) Inventors: Bobbie Jo Meredith, Smyrna, TN (US); James Clark, Murfreesboro, TN (US); Rafee Syed, Brentwood, TN (US); John C. Van Gorp, Sidney (CA)

(21) Appl. No.: 13/168,185

(22) Filed: Jun. 24, 2011

(51) Int. Cl. G06F 1/26

(52) U.S. Cl. 700/291; 700/297

(57) ABSTRACT

According to one aspect, embodiments of the invention provide a system for a facility, comprising a central controller configured to monitor power drawn by loads in the facility from a power source, and a plurality of load controllers, each configured to control an operational status of an associated load, to be coupled to the central controller, and to transmit a power request from the associated load to the central controller, and wherein the central controller comprises a power profile for each one of the associated loads, and is configured to receive a power request and conduct an evaluation of the power request based on current power drawn by loads in the facility, power capacity available, and the power profiles, and based on the evaluation provide a response to control an operational state of a load associated with the at least one of the plurality of load controllers.

### BACKGROUND OF INVENTION

1. Field of Invention

The present invention relates to systems and methods for managing the operation of loads in an energy system such that the aggregate operation of the loads does not exceed the capacity of the energy system.

2. Discussion of Related Art

An important factor in the design of an energy system is the maximum amount of power that can be instantaneously delivered to loads attached to the energy system. Absent an adequate maximum amount of power capable of being instantaneously delivered by the energy system, loads coupled to the energy system may not receive sufficient power.

### SUMMARY OF INVENTION

At least one aspect of the invention is directed to a power management system for a facility. The power management system may comprise a central controller configured to be coupled to a power source and to monitor power drawn by loads in the facility from the power source, and a plurality of load controllers, each configured to be coupled to an associated load, to control an operational status of the associated load, to be coupled to the central controller via a communications network, and to transmit a power request from the associated load to the central controller via the communications network, and wherein the central controller comprises a power profile for each one of the associated loads, and is configured to receive a power request from at least one of the plurality of load controllers and conduct an evaluation of the power request based on current power drawn by loads in the facility, power capacity available from the power source, and the power profiles of each one of the associated loads, and based on the evaluation provide a response to the at least one of the plurality of load controllers to control an operational state of a load associated with the at least one of the plurality of load controllers.

According to one embodiment, the central controller further comprises a queue, and wherein, based on the evaluation, at least one of the associated loads is entered into the queue. According to another embodiment, at least one of the plurality of load controllers is configured to be coupled to an electric vehicle and the central controller includes a power profile for the electric vehicle. According to one embodiment, at least one of the plurality of load controllers is configured to be located within the associated load.

According to one embodiment, each one of the power profiles represents power draw of an associated load over a period of time. In another embodiment, at least one power profile represents power draw of an associated load having more than two modes of operation. In one embodiment, at least one of the power profiles is preprogrammed into the central controller. In another embodiment, at least one of the power profiles is determined by one of the plurality of load controllers and transmitted to the central controller.

According to another embodiment, at least one of the power profiles of an associated load includes at least one load management rule. In one embodiment, the at least one load management rule includes an indication of whether operation of the associated load is able to be interrupted. In another embodiment, the at least one load management rule includes an indication of a relative priority of the associated load.

In another aspect, the invention is directed to a power management method for a facility. The method may comprise receiving an indication of power capacity available from a power source, monitoring current power drawn by loads in the facility from the power source, associating, by a central controller, a power profile with each one of the loads, receiving, by the central controller, a power request from a first load controller coupled to a first one of the loads, evaluating the power request based on current power drawn by loads in the facility, power capacity available from the power supply, and the power profiles of each one of the loads, and providing, based on the act of evaluating, a response to the first load controller to control an operational state of the first one of the loads.

According to one embodiment, the method further comprises monitoring, by the first load controller, power drawn by the first one of the loads, generating, in response to the act of monitoring, the power profile associated with the first one of the loads, and transmitting the power profile to the central controller. According to another embodiment, the method further comprises providing, based on the act of evaluating, a response to a second load controller to control an operational state of a second one of the loads coupled to the second load controller. According to one embodiment, the method further comprises adding, by the central controller, the second one of the loads to a queue.

According to another embodiment, the act of providing includes an act of providing a response to the first load controller to change the operational state of the first one of the loads to a low power operational state.

According to one embodiment, the method further comprises evaluating the current power drawn by loads in the facility, power capacity available from the power supply, and the power profiles of each one of the loads, and dequeuing, based on the act of evaluating the current power drawn, power capacity and power profiles, the second one of the loads and providing a signal to the second load controller to control an operational state of the second one of the loads.

In one aspect, the invention is directed to a non-transitory computer-readable medium encoded with instructions for execution on a central controller within a facility, the instructions when executed, performing a method comprising acts of receiving an indication of power capacity available from a power source, receiving an indication of current power drawn by loads in the facility from the power source, associating a power profile with each one of the loads, receiving a power request from a first load controller coupled to a first one of the loads, evaluating the power request based on current power drawn by loads in the facility, power capacity available from the power supply, and the power profiles of each one of the loads, and providing, based on the act of evaluating, a response to the first load controller to control an operational state of the first one of the loads.

According to one embodiment, the sequences of instruction include instructions that will cause the central controller to provide, based on the act of evaluating, a response to a second load controller to control an operational state of a second one of the loads coupled to the second load controller. According to another embodiment, the sequences of instruction include instructions that will cause the central controller to add the second one of the loads to a queue.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an energy management system according to aspects of one embodiment of the current invention;

FIG. 2A illustrates a first power profile according to aspects of one embodiment of the current invention;

FIG. 2B illustrates a second power profile according to aspects of one embodiment of the current invention;

FIG. 2C illustrates a third power profile according to aspects of one embodiment of the current invention;

FIGS. 3A and 3B illustrate a process flowchart of an energy management system according to aspects of the one embodiment of the current invention; and

FIG. 4 shows an example computer system with which various aspects disclosed herein may be implemented;

### DETAILED DESCRIPTION

Various embodiments and aspects thereof will now be discussed in detail with reference to the accompanying drawings. It is to be appreciated that this invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

As discussed above, an important factor in the design of an energy system is the maximum amount of power that can be instantaneously delivered to loads attached to the energy system. Over time, changes in load operation (e.g., loads being powered on or off) or the addition or removal of loads attached to the energy system, can eventually lead to an instantaneous power draw that exceeds the capacity of the energy system and/or safety levels programmed into protective equipment within the energy system, forcing loads and electrical circuits in the system to be disconnected.

For example, an energy system of a residential facility may be designed to provide a certain maximum power level capable of being instantaneously delivered to loads (e.g., to appliances, electronics, lighting, etc.) attached to the energy system. However, if a large load (e.g., an electric vehicle) is suddenly coupled to the energy system, the instantaneous power draw of the loads coupled to the energy system may exceed the capacity of the energy system and overload the energy system.

To compensate for such large instantaneous power draws, a conventional energy system may be reconfigured to handle a higher total power capacity. But this process can be both expensive and time-consuming. Alternatively, based on the known power requirements of loads attached to a conventional energy system, the energy system may be configured to pre-schedule the timing of when power is provided to each of the attached loads to avoid a high instantaneous power draw. In such a system, the predefined power schedule is static and the energy system may be unable to adequately handle unanticipated power requests.

In at least one embodiment described herein, an energy management system is provided that coordinates the operation of attached loads in response to energy requests such that the aggregate operation of the loads at any one time does not exceed the capacity of the electrical circuit feeding the loads.

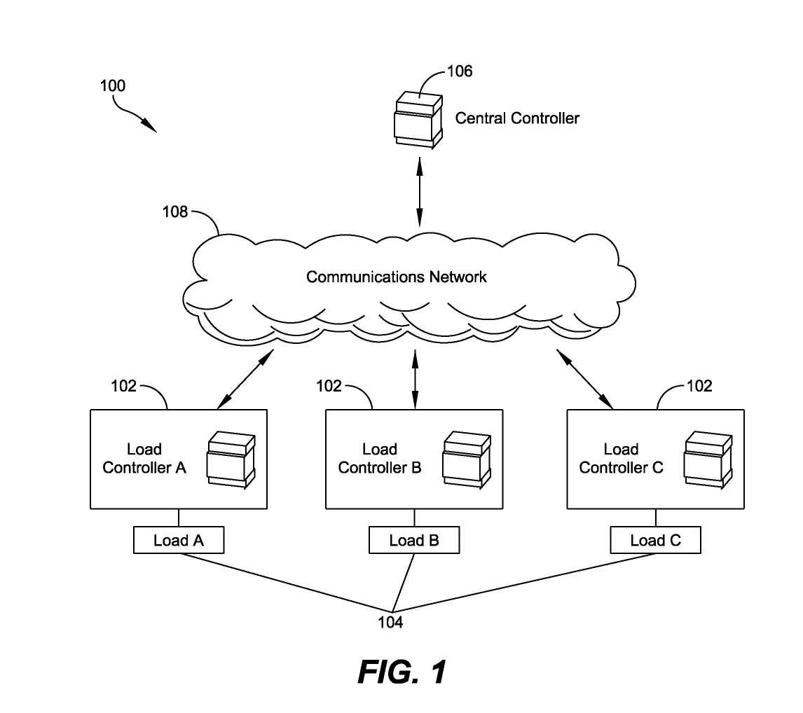

FIG. 1 is a block diagram of an energy management system 100 according to aspects of one embodiment of the current invention. The energy management system 100 includes a plurality of load controllers 102 (e.g., load controllers A, B and C), each configured to be coupled to an associated load 104 (e.g., loads A, B, or C respectively) that receives power from an external power supply system (e.g., a utility power supply system) (not shown). According to one embodiment, at least one of the load controllers 102 is located within its associated load 104 (i.e. within the same housing as the load 104). According to another embodiment, at least one of the load controllers 102 is located adjacent to its associated load 104 (e.g., attached to the outside housing of the load 104 or coupled between the load 104 and a nearby utility power socket). According to another embodiment, at least one of the load controllers 102 is located somewhere within the electrical infrastructure supplying power to the load 104 (e.g., in the breaker panel (not shown) to which the load 104 is coupled).

According to one embodiment, each one of the plurality of load controllers 102 is configured to control the operation of its associated load 104. For example, each one of the load controllers 102 is configured to control different operating modes of its associated load 104. According to one embodiment, at least one load controller 102 is configured to switch its associated load between two modes of operation (e.g., an “on” mode of operation and an “off” mode of operation). In another embodiment, at least one load controller 102 is configured to switch its associated load between more than two modes of operation (e.g., an “on” mode, an “off” mode, a “standby” mode, a “power-up” mode, a “power-down” mode, a “high” power mode, and a “low” power mode, etc), with each mode potentially requiring a different amount of energy (e.g., a “high” power “on” mode or a “low” power “standby” mode) and utilizing the energy in a different way.

For example, an air conditioning unit may have three different modes; a “high” power mode requiring a high amount of energy to run the air conditioner at maximum capacity, a “low” power mode requiring a lower amount of energy to run the air conditioner at a level less than maximum capacity, and an “off” mode requiring no energy. According to other embodiments, each one of the plurality of load controllers 102 may be configured to control an associated load 104 having any number and/or type of operating modes.

According to one embodiment, the energy management system 100 also includes a central controller 106. In one embodiment, the central controller 106 is coupled to each one of the plurality of load controllers 102 via a communications network 108. According to one embodiment, the communications network 108 is a wired communications network (e.g., a Local Area Network (LAN)) and the central controller 106 and load controllers 102 are configured to communicate via wired interfaces (e.g., via USB port, serial port, Ethernet port, Power Line Communication (PLC) port, or any other type of interface). According to another embodiment, the communications network 108 is a wireless communications network (e.g., a Wireless Local Area Network (WLAN)) and communication between the central controller 106 and load controllers 102 may be performed in compliance with a wireless standard such as the ZigBee RF4CE standard, the IEEE 802.15 standard, a Bluetooth standard, or any other wireless standard.

According to one embodiment, while the plurality of load controllers 102 individually control their associated loads 104, the central controller 106 is configured to communicate with all of the load controllers 102 and coordinate the operation of the plurality of load controllers 102. In one embodiment, the central controller 106 coordinates the operational status for each load 104 coupled to the plurality of load controllers 102. For example, the central controller 106 monitors the plurality of loads 104 and, when necessary, sends a command, via the communication network 108, to a desired load controller 102 to switch the operating mode of the load 104 associated with the load controller 102. In another embodiment, a load controller 102, which desires to switch operating modes of its associated load 104, contacts the central controller 106 and requests to switch the associated load 104 to a desired mode. The central controller 106 may either accept or deny the request.

According to another embodiment, in addition to receiving and processing information from the plurality of load controllers 102 regarding the current operating modes of associated loads 104, the central controller 106 may also confirm the operating mode of different loads 104 directly using one or more monitoring devices. For example, in one embodiment, the central controller 106 confirms the operating modes of different loads 104 through the use of a current monitoring device. By monitoring the current to different loads 104, the central controller 106 may be able to confirm the current operating modes of the loads 104. In other embodiments, different monitoring devices such as voltage monitoring devices and/or power monitoring devices may be utilized to confirm the operational mode of the loads 104.

According to one embodiment, by communicating with the loads 104, controlling the operational modes of the loads 104, and/or confirming the operational status of the loads 104, the central controller 106 is able to manage the loads 104 so that the aggregate operation of the loads 104, at any one time, does not exceed the capacity of the external power supply system.

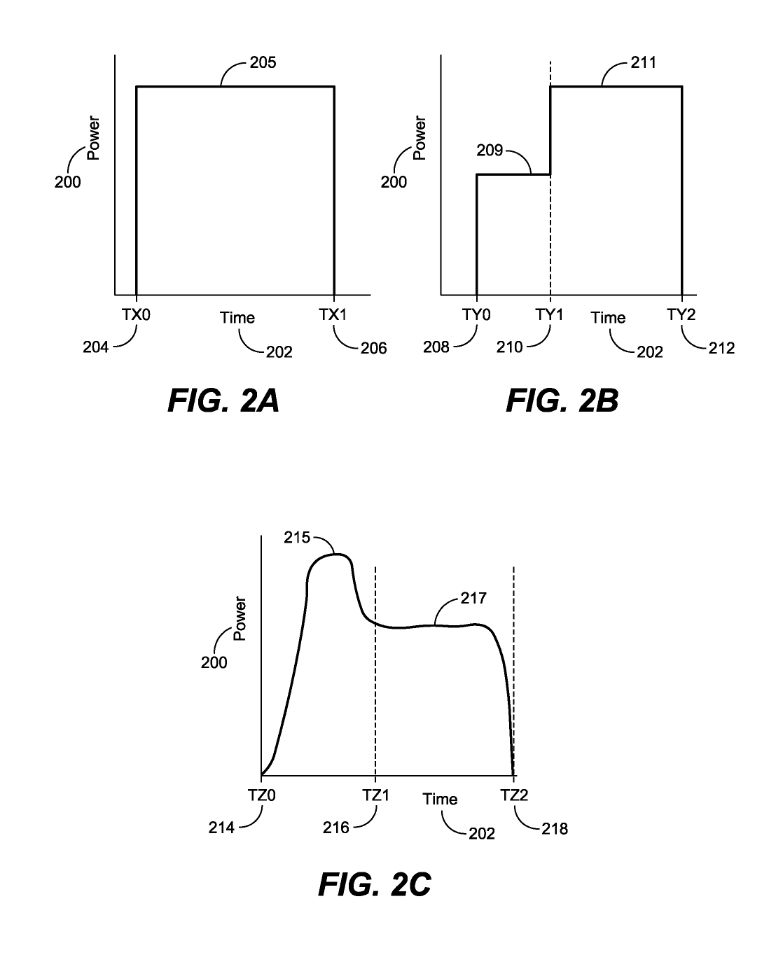

According to one embodiment, the central controller 106 monitors each load 104 by utilizing power profiles associated with each load 104. A power profile describes how a load 104 draws power over time. FIGS. 2A, 2B and 2C illustrate example power profiles as plots of power draw 200 vs. time 202. The power profile illustrated in FIG. 2A illustrates a load 104 having dual operating modes (i.e. “on” and “off” modes). For example, when the load 104 is switched on at time TX0 204, the load 104 draws power 205, and when the load 104 is switched off at time TX1 206, the load 104 draws no power.

The power profile illustrated in FIG. 2B illustrates a load 104 having more than two operating modes (i.e. a first “on” mode, a second “on” mode and an “off” mode). For example, when the load 104 is switched on at time TY0 208, the load 104 draws a first power level 209 in a first “on” mode. When the load 104 is switched to a second “on” mode at time TY1 210, the load 104 increases its power draw to a second level 211 and when the load 104 is switched off at time TY2 212, the power draw of the load 104 drops to zero.

In both FIGS. 2A and 2B, power 200 is illustrated as instantaneously moving between power draw levels (e.g., from zero to level 205 at time TX0 204 or from level 209 to level 211 at time TY1 210). However, FIG. 2C illustrates a power profile of a load 104 in which power level transition it not instantaneous and takes a period of time. For example, when the load 104 is switched on at time TZ0 214, the instantaneous power consumed by the load 104 rises to a peak level 215, before dropping to a relatively constant level 217 during normal operation of the load 104. According to one embodiment, with such a power profile as illustrated in FIG. 2C, the central controller 106 is configured to use an approximate load profile model with three operating modes: one with power level 215 (between times TZ0 214 and TZ1 216), one with power level 217 (between times TZ1 216 and TZ2 218), and one with zero power level after time TZ2 218.

Utilizing the power profiles associated with each load 104, the central controller 106 is able to coordinate the operation of the loads 104 such that the total instantaneous power draw at any point in time does not exceed the maximum available capacity. For example, while a first load 104 is operating with the power profile illustrated in FIG. 2A, a second load 104 with the power profile illustrated in FIG. 2B may request permission to start up. However, even if the combination of the instantaneous power levels 205 from the first load 104 and 209 from the second load 104 does not currently exceed the maximum available capacity of the energy system, the central controller 106 may still prevent the second load 104 from starting up if the combination of the power levels 205 from the first load 104 and 211 from the second load 104 does exceed the maximum available capacity of the energy system. Thus, the central controller 106 not only compares the current instantaneous power draw of loads coupled to the energy system with the maximum available capacity, but also compares the future power draw of loads (based on power profiles) coupled to the energy system with the maximum available capacity. In this way, current and future energy conflicts may be avoided.

According to one embodiment, when making a determination on whether to grant a power request, the central controller 106 compares the request with the power profiles of all loads currently coupled to the energy system. In this way, even if a load is not currently drawing power, the central controller 106 may determine future needs of the loads and grant or deny the power request accordingly. According to one embodiment, in addition to determining whether to grant or deny a power request, the central controller 106 is also configured to determine whether a power request should be delayed. For example, in response to a power request, the central controller 106 may determine that the power request cannot currently be granted, but may be grantable in the future. As a result, the central controller 106 places the power request in a queue to be handled at a later time when requested power becomes available.

According to other embodiments, the central controller 106 may be configured to compare power requests with only a select portion of the loads coupled to the energy system. In one embodiment, the select portion may be based on characteristics of the loads, such as the type of loads, the size of the loads, the operational status of the loads, or any other appropriate characteristic.

According to one embodiment, the power profile information for each load 104 is preprogrammed into the central controller 106. For example, in one embodiment, a user may enter profile information into the central controller 106 via a user interface (e.g., a control panel) (not shown). According to another embodiment, the power profile information of each load 104 is preprogrammed into each load's associated load controller 102 and each load controller 102 transmits the power profile information to the central controller 106.

According to another embodiment, the power profile information of each load 104 may be learned by the central controller 106. For instance, utilizing monitoring devices as discussed above, the central controller 106 may monitor the power draw of each load over a certain time period, identify different modes of operation based on the power draw of each load 104, and generate a power profile for each load 104 based on the modes of operation. For example, in one embodiment, the central controller 106 generates power profiles of each load by monitoring current to each load over time, monitoring current peaks of each load, and monitoring when each load turns off.

According to another embodiment, the power profile information of each load 104 may be learned by each load's 104 load controller 102 and transmitted to the central controller 106. For instance, utilizing monitoring devices as discussed above, each load controller 102 may monitor the power draw of its load over a certain time period, identify different modes of operation based on the power draw of the load 104, and generate a power profile for the load 104 based on the modes of operation. For example, in one embodiment, each load controller 102 generates a power profile of its associated load by monitoring \ current to the load over time, monitoring current peaks of the load, and monitoring when the load turns off.

According to one embodiment, in addition to power characteristics and operating modes of associated loads 104, power profiles also include additional information related to the associated loads 104. For example, in one embodiment, a power profile may also indicate whether an associated load 104 is interruptible. For instance, some loads may be required to complete an operating mode, or a sequence of operating modes, before they are able to be interrupted. With such a load 104, the power profile will indicate to the central controller 106 that the load 104 is uninterruptible. Hence, once the associated load controller 102 is granted permission to initiate the operating mode (or sequence of operating modes), the central controller 106 may not interrupt the load operation.

According to another embodiment, power profiles also indicate to the central controller 106 whether operating modes of an associated load 104 have a definite or indefinite end time. For example, a power profile may indicate to the central controller 106 that its associated load 104 will definitely turn off at a given time. Thus, the central controller can count on the associated load 104 not requiring power after the given time. Alternatively, some power profiles may indicate to the central controller that their associated load 104 does not have a definite end time. In such a situation, according to one embodiment, the load controller 102 coupled to the associated load 104 signals the central controller 106 once an operating mode with an indeterminate end time has completed. According to another embodiment, the central controller 106 uses monitoring devices, as discussed above, to determine when the operating mode has completed.

In one embodiment, in addition to power profiles including information describing how a load 104 will draw power when initialized, power profiles are also accompanied by “models” that describe a desired result that one or more operating modes of the associated load 104 are designed to accomplish. The central controller 106 may be configured to leverage such a “model” to optimize operation of the associated load 104 to achieve the desired result while also balancing the needs of other loads 104 in the energy system. For example, a home electric baseboard heating load may include a power profile accompanied with a model describing how baseboard energy consumption is related to an increase in indoor temperature and changes in outdoor temperature. During the night, the central controller 106 may need to balance the needs of two competing large loads: the baseboard heating load and an Electric Vehicle (EV) charger. Given the baseboard heating model and knowledge of the desired result (e.g., such as a minimum indoor temperature), the central controller may alternate between the two loads 104 in order to maintain the minimum indoor temperature.

In addition to power usage information, operating modes, interruptibility, end times, and “models”; the central controller 106 may also take into account other characteristics related to the loads 104 (e.g., such as relative priority, scheduling requirements, dependencies, or any other information related to the loads 104) when managing the loads 104. Based on such information, the central controller 106 can determine whether to grant or deny power requests from the load controllers 102 and also how to manage the loads 104 (e.g., by turning on loads 104, turning off loads 104, or altering operational status of loads 104) so as to coordinate the loads 104 such that the aggregate operation of controlled loads 104 at any one time does not exceed the capacity of the energy system.

For example, according to one embodiment, the central controller 106 may draw upon a collection of load management rules to determine how best to manage the operation of the loads 104 under the maximum capacity of the energy system.

Each one of the load management rules may correlate to one or more loads and each rule may incorporate one or more parameters or characteristics related to the loads. In one embodiment, each rule may be expressed in terms of one or more other rules. For example, the rules may be chained together in a particular sequence, where the sequence is expressed using some form of conditional programming For instance, sequences of rules may be expressed using IF/THEN conditional programming In other embodiments, other types of conditional programming or other types of evaluation structures commonly found in computer programming languages may be utilized.

Examples of parameters that may be incorporated into load management rules include:
The current operational status of loads 104 in the energy system 100 (e.g., “off”, “on”, or some other operating mode);
The maximum aggregate energy draw of loads 104 in the energy system 100;
Current measurements of load 104 energy usage (e.g., voltage, current, power; etc).
The power profile of each load 104 in the energy system 100;
Current requests from load controllers 102 to switch a load 104 to a particular operating mode;
Environmental measurements (e.g., temperature, humidity, etc.);
Established load operating schedules (e.g., allowed hours of the day, allowed days of the week, restrictions, definite end times etc.);
Load 104 operation flexibility (e.g., a load can operate any time between time X and Y, but it is guaranteed to run once every Z hours, interruptibility);
User override signal (e.g., indication from a user to immediately start a load 104);
Load 104 priority (relative to other loads 104);
Load 104 operation dependencies (e.g., Load A and Load B must operate together.

According to one embodiment, the collection of rules may be defined such that the central controller 106 first checks to confirm that the energy system 100 has capacity for at least one load 104 to switch to an active operating mode. The central controller may then wait for power requests from the load controllers 102. Based on the collection of rules, the central controller 206 can determine whether to grant or deny the power requests from the load controllers 102 and also how to manage the loads 104 (e.g., by turning on loads 104, turning off loads 104, or altering operational status of loads 104) to coordinate the loads 104 such that the aggregate operation of controlled loads 104 at any one time does not exceed the capacity of the energy system.

For example, according to one embodiment, a washing machine and an EV charger are coupled to the same energy system. The washer may have the following parameters:
Simple On/Off power profile with On operating mode requiring 20 amps;
Priority=1;
Schedule=on demand;
Interruptible?=No (e.g., once started, the central controller 106 cannot interrupt).

The EV charger may have the following parameters:
Simple On/Off power profile with On operating mode requiring 50 amps;
Priority=3
Schedule=10 pm to 6 am
Interruptible?=Yes (e.g., the central controller 106 can interrupt operation).

According to one embodiment, if the washer is currently running and the load controller 102 of the EV charger sends a request to the central controller 106 to switch the EV charger to the charging operating mode, the central controller 106 analyzes the parameters of the washer and EV charger listed above along with the available power available from the energy system and in response, either grants or denies the power request from the EV charger. In one embodiment, where the energy system is not able to sustain both the washer and the EV charger, the central controller 106 notes, based on the defined parameters of the washer, that the washer cannot be interrupted once started and hence, may seek other loads coupled to the energy system that can be interrupted, in order to make power available for the EV charger.

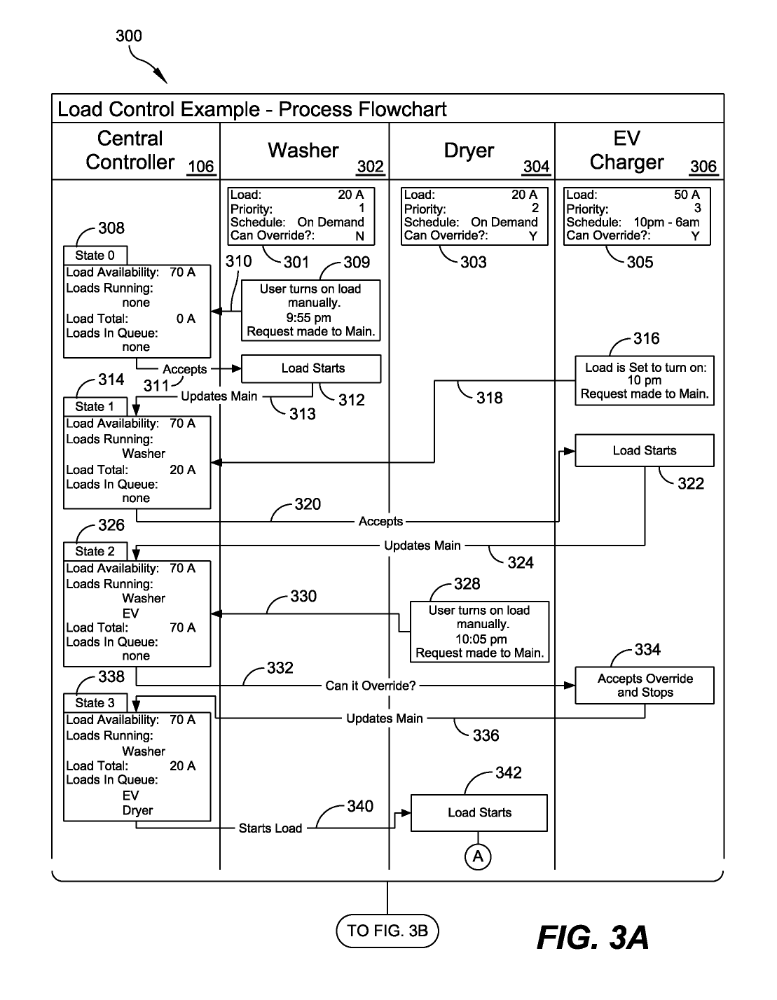

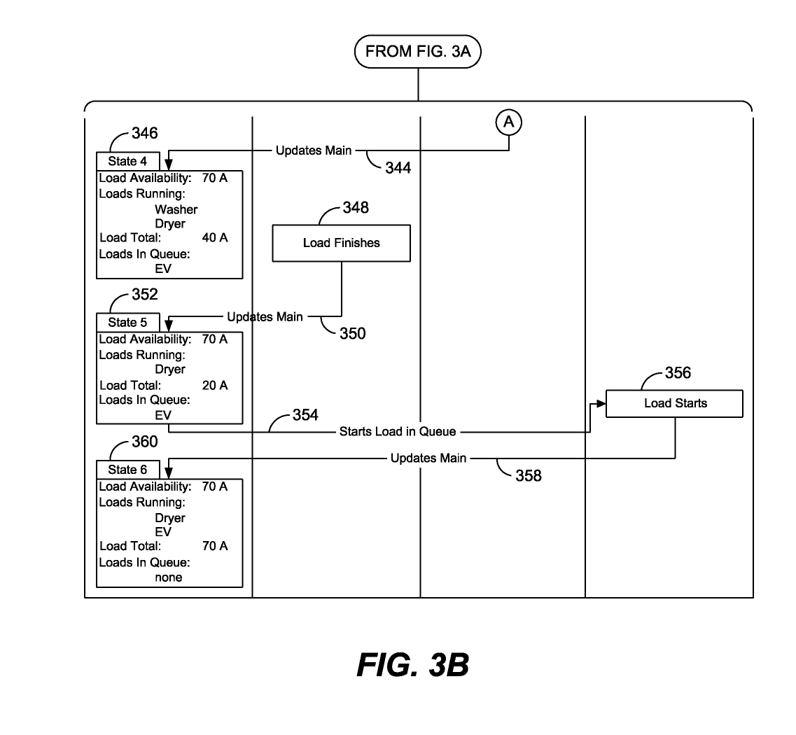

According to another embodiment where the energy system 100 is already providing power to the EV charger, the central controller 106 is configured to allow other loads 104 to interrupt the operation of the EV charger at various times over the night (i.e. 10 pm to 6 am), but also ensures that the EV charger is allowed to operate long enough during its nighttime schedule such that any electric cars connected to the EV charger are fully charged before the 6 am end time. The coordination of loads by the central controller 106 is discussed in greater detail with reference to FIGS. 3A and 3B.

FIGS. 3A and 3B illustrate a process flowchart 300 of an energy management system 100 according to aspects of one embodiment of the current invention. FIGS. 3A and 3B provide an example of a central controller 106 coordinating the operation of several household loads 104. The central controller 106 coordinates the operation of a washer 302 (with parameters as described above), a dryer 304, and an EV charger (with parameters as described above). Within FIGS. 3A and 3B, actions taken by the central controller 106 are shown in a series of boxes running downward, underneath the central controller 106 heading, with each box indicating the current state of the managed loads 302, 304, 306 and available energy system capacity (express in amps). Boxes in the columns under each load 302, 304, 306 indicate actions taken by the load's associated load controller 102, with arrows connecting the actions to the associated state of the energy system 100 as managed by the central controller 106.

As illustrated in FIGS. 3A and 3B, the energy system 100 has a maximum capacity of 70 amps. Also as illustrated in FIG. 3A, each of the loads 302, 304, 306 has designated parameters 301, 303, and 305 respectively. According to the designated parameters 301, 303, 305, the washer 302 and dryer 304 each represent a load of 20 amps, and the EV charger 306 represents a load of 50 amps. According to the designated parameters 301, 303, 305, each of the loads 302, 304, 306 has a simple ON/OFF power profile (e.g., similar to the profile illustrated in FIG. 2A above) and each of the loads 302, 304, 306 has priority and schedule designations. In addition, according to one embodiment, the washer 302, once started, cannot be interrupted (i.e., it cannot be stopped once the selected washing cycle has started).

At initial state zero 308, all the loads 302, 304, 306 are OFF and no loads have requested power to start. At action 309 (i.e. 9:55 pm), a user initiates the start of wash cycle on the washer 302, at which point the washer's load controller 102 sends a request 310 to the central controller 106. The central controller 106 determines that the energy system is able to supply the requested 20 amps to the washer and sends an acknowledgement 311 to the washer 302, indicating to the washer 302 that the washer can begin its wash cycle. At action 312, the wash cycle of the washer 302 begins and an update signal 313 is sent to the central controller 106.

At state one 314, the washer 302 is drawing 20 amps of the maximum 70 amps available. At action 316 (i.e. at 10 pm), the EV charger 306, which is schedule to operate between 10 pm and 6 am (as required to charge any attached electric vehicles), sends a power request 318 to the central controller 106. Having knowledge of the power profile of the EV charger (i.e. constant draw of 50 amps) and the current status and future demands of other loads (i.e. washer 302 on, drawing 20 amps and no future demands in queue), the central controller grants the EV charger's 306 request to start and sends an acknowledgement 320 to the EV charger 306. At action 322, the EV charger begins its charging mode and sends an update signal to the central controller 106.

At state two 326, both the washer 302 and the EV charger 306 are operating and drawing the maximum available system capacity of 70 amps. At action 328 (i.e. 10:05 pm), a user manually starts the dryer 304. The dryer's associated load controller 102 sends a request 330 to the central controller 106. At this time, the electrical system is running at its capacity of 70 amps so the dryer 304 is placed into the central controller's 106 queue. However the EV charger power profile indicates that its current operating mode can be interrupted and the dryer has a higher priority designation than the EV charger, so the central controller 106 sends an override request 332 to the EV charger 306. At action 334, the EV charger 306 accepts the override command, stops its charging cycle and responds with an acknowledgement and update 336.

At state three 338, the EV charger 306 has accepted the central controller's 106 override request, has shut down, and has been placed into the central controller's 106 queue to return to service once sufficient system capacity is available (and any other load management rules, if applicable, are satisfied). The dryer 304 is also in the central controller's 106 queue. However, once the central controller 106 receives the acknowledgment 336 from the EV charger 306 that the EV charger 306 has shut down, the central controller 106 sends a signal 340 to the dryer 304 to start the dryer 304 (as previously initiated by the user) and removes the dryer 304 from its queue. At action 342, the dryer begins and an update 344 (illustrated in FIG. 3B) is sent to the central controller 106.

As illustrated in FIG. 3B, at state four 346, both the washer 302 and dryer 304 are running and only the EV charger 306 is in the central controller queue. At action 348, the washer 302 finishes its wash cycle, shuts down and its load controller 102 sends an update 350 to the central controller 106 confirming that the washer operating mode, previously approved, has been completed.

At state five 352, the central controller 106 checks for pending operations in the queue, notes the EV charger 106 entry, and confirms that enough system capacity is now available to power the EV charger 106. According to one embodiment, the central controller 106 may also check other applicable load management rules to ensure that they are being followed. The central controller 106 then sends a command 354 to the EV charger 306 to resume operation. At action 356, the EV charger 306 resumes its charging operating mode and sends an update 358 to the central controller 106.

At state six 360, both the dryer 304 and EV charger 406 are operating and no pending requests remain in the queue. As a result, all three appliances were able to operate according to their power profiles without overloading the power system.

As described herein, the energy management system 100 is utilized within a residential facility; however, in other embodiments, the energy management system 100 may be utilized in any other facility (e.g., in a commercial or industrial unit) which may benefit from the power management of multiple loads.

Various aspects and functions described herein may be implemented as hardware or software on one or more computer systems. There are many examples of computer systems currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, examples are not limited to executing on any particular system or group of systems. Further, aspects may be implemented in software, hardware or firmware, or any combination thereof. Thus, aspects may be implemented within methods, acts, systems, system elements and components using a variety of hardware and software configurations, and examples are not limited to any particular distributed architecture, network, or communication protocol.

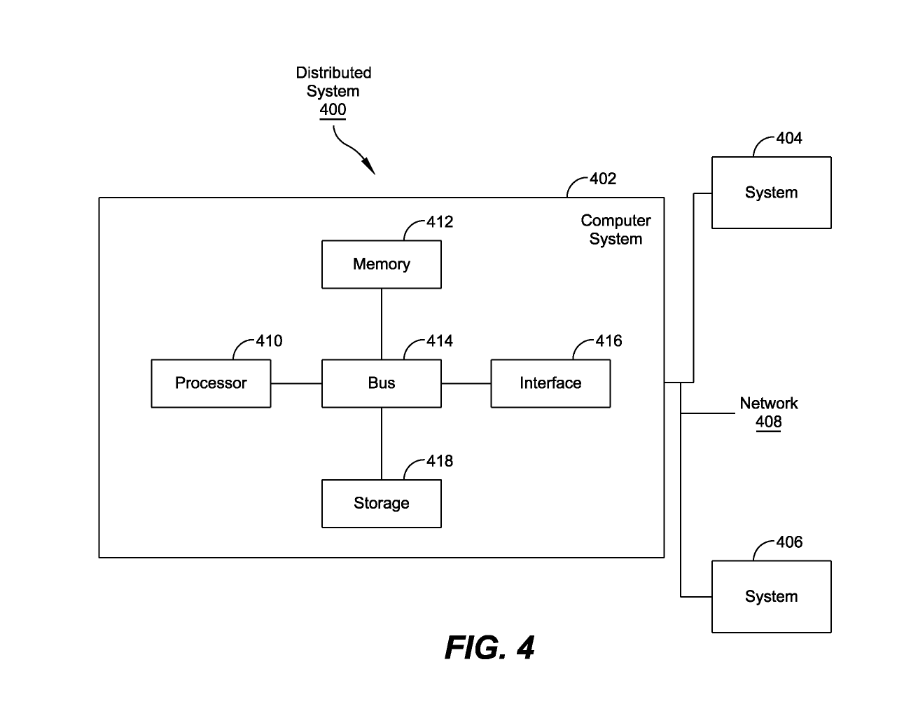

FIG. 4 shows a block diagram of a distributed computer system 400, in which various aspects and functions may be practiced. Distributed computer system 400 may include one or more computer systems. For example, as illustrated, distributed computer system 400 includes computer systems 402, 404 and 406. As shown, computer systems 402, 404 and 406 are interconnected by, and may exchange data through, communication network 408. Network 408 may include any communication network through which computer systems may exchange data. To exchange data using network 408, computer systems 402, 404 and 406 and network 408 may use various methods, protocols and standards, including, among others, token ring, ethernet, wireless ethernet, Bluetooth, TCP/IP, UDP, Http, FTP, SNMP, SMS, MMS, SS7, JSON, Soap, and Corba. To ensure data transfer is secure, computer systems 402, 404 and 406 may transmit data via network 408 using a variety of security measures including TLS, SSL or VPN among other security techniques. While distributed computer system 400 illustrates three networked computer systems, distributed computer system 400 may include any number of computer systems and computing devices, networked using any medium and communication protocol.

Various aspects and functions disclosed herein may be implemented as specialized hardware or software executing in one or more computer systems including computer system 402 shown in FIG. 4. As depicted, computer system 402 includes processor 410, memory 412, bus 414, interface 416 and storage 418. Processor 410 may perform a series of instructions that result in manipulated data. Processor 410 may be a commercially available processor such as an Intel Pentium, Motorola PowerPC, SGI MIPS, Sun UltraSPARC, or Hewlett-Packard PA-RISC processor, but may be any type of processor or controller as many other processors and controllers are available. Processor 410 is connected to other system elements, including one or more memory devices 412, by bus 414.

Memory 412 may be used for storing programs and data during operation of computer system 402. Thus, memory 412 may be a relatively high performance, volatile, random access memory such as a dynamic random access memory (DRAM) or static memory (SRAM). However, memory 412 may include any storage device for storing data, such as a disk drive or other non-volatile storage device. Various examples may organize memory 412 into particularized and, in some cases, unique structures to perform the aspects and functions disclosed herein.

Components of computer system 402 may be coupled by an interconnection element such as bus 414. Bus 414 may include one or more physical busses, for example, busses between components that are integrated within a same machine, but may include any communication coupling between system elements including specialized or standard computing bus technologies such as IDE, SCSI, PCI and InfiniBand. Thus, bus 414 enables communications, for example, data and instructions, to be exchanged between system components of computer system 402.

Computer system 402 also includes one or more interface devices 416 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow computer system 402 to exchange information and communicate with external entities, such as users and other systems.

Storage system 418 may include a computer readable and writeable nonvolatile storage medium in which instructions are stored that define a program to be executed by the processor. Storage system 418 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, the processor or some other controller may cause data to be read from the nonvolatile recording medium into another memory, such as memory 412, that allows for faster access to the information by the processor than does the storage medium included in storage system 418. The memory may be located in storage system 418 or in memory 412, however, processor 410 may manipulate the data within the memory 412, and then copies the data to the medium associated with storage system 418 after processing is completed. A variety of components may manage data movement between the medium and integrated circuit memory element and examples are not limited thereto. Further, examples are not limited to a particular memory system or storage system.

Although computer system 402 is shown by way of example as one type of computer system upon which various aspects and functions may be practiced, aspects are not limited to being implemented on the computer system as shown in FIG. 4. Various aspects and functions may be practiced on one or more computers having different architectures or components than that shown in FIG. 4. For instance, computer system 402 may include specially-programmed, special-purpose hardware, such as for example, an application-specific integrated circuit (ASIC) tailored to perform a particular operation disclosed herein, while another example may perform the same function using several general-purpose computing devices running MAC OS System X with Motorola PowerPC processors and several specialized computing devices running proprietary hardware and operating systems.

Computer system 402 may be a computer system including an operating system that manages at least a portion of the hardware elements included in computer system 402. Usually, a processor or controller, such as processor 410, executes an operating system which may be, for example, a Windows-based operating system, such as, Windows NT, Windows 2000 (Windows ME), Windows XP or Windows Vista operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating system available from various sources. Many other operating systems may be used, and examples are not limited to any particular implementation.

The processor and operating system together define a computer platform for which application programs in high-level programming languages may be written. These component applications may be executable, intermediate, for example, C−, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, examples are not limited to a specific programming language and any suitable programming language could also be used. Further, in at least one example, the tool may be implemented using VBA Excel.

A computer system included within an example may perform additional functions. For instance, aspects of the system may be implemented using an existing commercial product, such as, for example, Database Management Systems such as SQL Server available from Microsoft of Seattle Wash., Oracle Database from Oracle of Redwood Shores, CA, and MySQL from MySQL AB of Uppsala, Sweden or integration software such as Web Sphere middleware from IBM of Armonk, NY. However, a computer system running, for example, SQL Server may be able to support both aspects disclosed herein and databases for sundry other applications.

As described herein, an energy management system is provided that instantaneously coordinates the operation of attached loads in response to energy requests such that the aggregate operation of the loads at any one time does not exceed the capacity of the electrical circuit feeding the loads. By comparing preprogrammed and/or learned profiles of the attached loads with received energy requests, the total available supply power available and the power currently being consumed by the attached loads, the energy management system is able to instantaneously operate the attached loads, based on current and future power needs of the loads, so that the aggregate operation of the loads does not exceed the capacity of the energy system.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A power management system for a facility, comprising:
a central controller configured to be coupled to a power source and to monitor power drawn by loads in the facility from the power source; and
a plurality of load controllers, each configured to be coupled to an associated load, to control an operational status of the associated load, to be coupled to the central controller via a communications network, and to transmit a power request from the associated load to the central controller via the communications network; and
wherein the central controller comprises a power profile for each one of the associated loads, and is configured to receive a power request from at least one of the plurality of load controllers and conduct an evaluation of the power request based on current power drawn by loads in the facility, power capacity available from the power source, and the power profiles of each one of the associated loads, and based on the evaluation provide a response to the at least one of the plurality of load controllers to control an operational state of a load associated with the at least one of the plurality of load controllers.

2. The power management system of claim 1, wherein the central controller further comprises a queue, and wherein, based on the evaluation, at least one of the associated loads is entered into the queue.

3. The power management system of claim 1, wherein at least one of the plurality of load controllers is configured to be coupled to an electric vehicle and the central controller includes a power profile for the electric vehicle.

4. The power management system of claim 1, wherein each one of the power profiles represents power draw of an associated load over a period of time.

5. The power management system of claim 4, wherein at least one power profile represents power draw of an associated load having more than two modes of operation.

6. The power management system of claim 1, wherein at least one of the power profiles is preprogrammed into the central controller.

7. The power management system of claim 1, wherein at least one of the power profiles is determined by one of the plurality of load controllers and transmitted to the central controller.

8. The power management system of claim 1, wherein at least one of the power profiles of an associated load includes at least one load management rule.

9. The power management system of claim 8, wherein the at least one load management rule includes an indication of whether operation of the associated load is able to be interrupted.

10. The power management system of claim 8, wherein the at least one load management rule includes an indication of a relative priority of the associated load.

11. The power management system of claim 1, wherein at least one of the plurality of load controllers is configured to be located within the associated load.

12. A power management method for a facility, comprising
receiving an indication of power capacity available from a power source;
monitoring current power drawn by loads in the facility from the power source;
associating, by a central controller, a power profile with each one of the loads;
receiving, by the central controller, a power request from a first load controller coupled to a first one of the loads;
evaluating the power request based on current power drawn by loads in the facility, power capacity available from the power supply, and the power profiles of each one of the loads; and
providing, based on the act of evaluating, a response to the first load controller to control an operational state of the first one of the loads.

13. The method of claim 12, further comprising:
monitoring, by the first load controller, power drawn by the first one of the loads;
generating, in response to the act of monitoring, the power profile associated with the first one of the loads; and
transmitting the power profile to the central controller.

14. The method of claim 12, wherein the act of providing includes an act of providing a response to the first load controller to change the operational state of the first one of the loads to a low power operational state.

15. The method of claim 12, further comprising providing, based on the act of evaluating, a response to a second load controller to control an operational state of a second one of the loads coupled to the second load controller.

16. The method of claim 15, further comprising, adding, by the central controller, the second one of the loads to a queue.

17. The power management method of claim 16, further comprising:
evaluating the current power drawn by loads in the facility, power capacity available from the power supply, and the power profiles of each one of the loads; and
dequeuing, based on the act of evaluating the current power drawn, power capacity and power profiles, the second one of the loads and providing a signal to the second load controller to control an operational state of the second one of the loads.

18. A non-transitory computer-readable medium encoded with instructions for execution on a central controller within a facility, the instructions when executed, performing a method comprising acts of:
receiving an indication of power capacity available from a power source;
receiving an indication of current power drawn by loads in the facility from the power source;
associating a power profile with each one of the loads;
receiving a power request from a first load controller coupled to a first one of the loads;
evaluating the power request based on current power drawn by loads in the facility, power capacity available from the power supply, and the power profiles of each one of the loads; and
providing, based on the act of evaluating, a response to the first load controller to control an operational state of the first one of the loads.

19. The non-transitory computer readable medium according to claim 18, wherein the sequences of instruction include instructions that will cause the central controller to provide, based on the act of evaluating, a response to a second load controller to control an operational state of a second one of the loads coupled to the second load controller.

20. The non-transitory computer readable medium according to claim 19, wherein the sequences of instruction include instructions that will cause the central controller to add the second one of the loads to a queue.
